(19) United States
(12) Patent Application Publication
(10) Pub. No.: US 2025/0309329 A1
(43) Pub. Date: Oct. 2, 2025

(54) METHOD FOR MANUFACTURING SOLID-STATE BATTERY

(71) Applicant: HONDA MOTOR CO., LTD., Tokyo (JP)

(72) Inventors: Yohei NOJI, Saitama (JP); Akihiro YOSHIZAWA, Saitama (JP); Takashi TOYOSHIMA, Saitama (JP); Kosei MIYATA, Saitama (JP); Takahiro MACHIDA, Saitama (JP); Nanae OMORI, Saitama (JP); Terumi FURUTA, Saitama (JP); Takayuki YAMAMOTO, Saitama (JP)

(21) Appl. No.: 19/063,321

(22) Filed: Feb. 26, 2025

(30) Foreign Application Priority Data
Mar. 29, 2024 (JP) 2024-056221

(51) Int. Cl. H01M 10/04; H01M 10/0585

(52) U.S. Cl. CPC H01M 10/0481; H01M 10/0585; H01M 2300/0065

(57) ABSTRACT

Provided is a method for manufacturing a solid-state battery having preferable battery performance with less occurrence of abnormal electrocrystallization. The method is a method for manufacturing a solid-state battery having an electrode laminate configured such that a negative electrode layer, an intermediate layer, a solid electrolyte layer, and a positive electrode layer are laminated in this order. The solid electrolyte layer includes a first solid electrolyte layer disposed on the negative electrode layer side, a second solid electrolyte layer disposed adjacent to the first solid electrolyte layer, and a third solid electrolyte layer disposed on the positive electrode layer side. The method includes Step 1, Step 2A, Step 3, and Step 4A.

This application is based on and claims the benefit of priority from Japanese Patent Application No. 2024-056221, filed on 29 Mar. 2024, the content of which is incorporated herein by reference.

### BACKGROUND OF THE INVENTION

### Field of the Invention

The present invention relates to a method for manufacturing a solid-state battery.

### Related Art

In recent years, research and development has been conducted on secondary batteries that contribute to energy efficiency in order to ensure that more people have access to affordable, reliable, sustainable, and advanced energy.

As a secondary battery, a solid-state battery such as a lithium metal battery or a lithium-ion secondary battery has been known, which is configured such that a solid electrolyte layer is disposed between a positive electrode layer and a negative electrode layer.

As a technique related to the solid-state battery, a technique related to an all-solid-state battery having a first solid electrolyte layer adjacent to a negative electrode and a second solid electrolyte layer located between the first solid electrolyte layer and a positive electrode and configured such that the first solid electrolyte layer has a smaller Young's modulus than that of the second solid electrolyte layer has been known (see, for example, Japanese Unexamined Patent Application, Publication No. 2022-108202).

Patent Document 1: Japanese Unexamined Patent Application, Publication No. 2022-108202

### SUMMARY OF THE INVENTION

The technique disclosed in Japanese Unexamined Patent Application, Publication No. 2022-108202 is intended to reduce degradation of interfacial contact between the solid electrolyte layer and the positive and negative electrode layers and suppress a decrease in a voltage upon self-discharge. A technique of decreasing the Young's modulus of the first solid electrolyte layer includes a technique of relatively increasing the content of a binder of the first solid electrolyte layer. However, the binder serves as a resistor in operation of the solid-state battery, and for this reason, the increase in the content of the binder of the solid electrolyte layer is not preferable.

A method for producing the above-described solid-state battery includes a method in which a positive electrode layer and a negative electrode layer are separately pressed and a solid electrolyte layer is then pressed with sandwiched between the positive electrode layer and the negative electrode layer such that these layers are integrated. However, each layer may be damaged if the pressure for the integration is too high, and for this reason, there is substantially an upper limit for the pressure for the integration. Thus, in some cases, the solid electrolyte layer cannot be sufficiently densified at an interface between the negative electrode layer and the solid electrolyte layer. Moreover, in some cases, the negative electrode layer and the solid electrolyte layer do not sufficiently closely adhere to each other. In a case where the degrees of densification and close adhesion above are insufficient, there are problems that abnormal electrodeposition occurs and required battery performance cannot be obtained.

The present invention has been made in view of the above-described situation, and an object thereof is to provide a method for manufacturing a solid-state battery having preferable battery performance with less occurrence of abnormal electrodeposition.

(1) The present invention relates to a method for manufacturing a solid-state battery having an electrode laminate configured such that a negative electrode layer, an intermediate layer, a solid electrolyte layer, and a positive electrode layer are laminated in this order, the solid electrolyte layer including a first solid electrolyte layer disposed on the negative electrode layer side, a second solid electrolyte layer disposed adjacent to the first solid electrolyte layer, and a third solid electrolyte layer disposed on the positive electrode layer side. The method includes obtaining an intermediate layer-negative electrode layer laminate by press-joining the negative electrode layer and the intermediate layer, obtaining a solid electrolyte layer-intermediate layer-negative electrode layer laminate by disposing a substance forming the first solid electrolyte layer on a lamination surface of the intermediate layer of the intermediate layer-negative electrode layer laminate and press-joining the intermediate layer-negative electrode layer laminate and the first solid electrolyte layer, obtaining a solid electrolyte layer-positive electrode layer laminate by disposing a substance forming the third solid electrolyte layer on a lamination surface of the positive electrode layer and press-joining the positive electrode layer and the third solid electrolyte layer, and obtaining an electrode laminate by disposing the second solid electrolyte layer between the solid electrolyte layer-intermediate layer-negative electrode layer laminate and the solid electrolyte layer-positive electrode layer laminate so as to face the solid electrolyte layers and press-joining the second solid electrolyte layer, the solid electrolyte layer-intermediate layer-negative electrode layer laminate, and the solid electrolyte layer-positive electrode layer laminate.

According to the aspect (1) of the invention, the method for manufacturing the solid-state battery having the preferable battery performance with less occurrence of the abnormal electrodeposition can be provided.

(2) In the method for manufacturing the solid-state battery according to (1), a pressure in the obtaining the solid electrolyte layer-intermediate layer-negative electrode layer laminate is higher than a pressure in the obtaining the electrode laminate.

According to the aspect (2) of the invention, the first solid electrolyte layer can be densified, and damage and excessive deformation of each layer can be prevented.

(3) In the method for manufacturing the solid-state battery according to (1) or (2), the pressure in the obtaining the solid electrolyte layer-intermediate layer-negative electrode layer laminate is more than 500 MPa and 700 MPa or less.

According to the aspect (3) of the invention, the first solid electrolyte layer can be reliably densified.

(4) In the method for manufacturing the solid-state battery according any one of (1) to (3), the pressure in the obtaining the electrode laminate is 300 MPa or more and 500 MPa or less.

According to the aspect (4) of the invention, damage and excessive deformation of each layer can be prevented.

(5) In the method for manufacturing the solid-state battery according to any one of (1) to (4), a pressure in the obtaining the solid electrolyte layer-positive electrode layer laminate is higher than the pressure in the obtaining the electrode laminate.

According to the aspect (5) of the invention, the third solid electrolyte layer can be densified, and the battery performance can be improved.

### BRIEF DESCRIPTION OF THE DRAWINGS

FIG. 1 is a conceptual sectional view showing the configuration of a solid-state battery according to an embodiment of the present invention;

FIG. 2A is a view showing part of a step in a method for manufacturing a solid-state battery according to a first embodiment of the present invention;

FIG. 2B is a view showing part of a step in the method for manufacturing the solid-state battery according to the first embodiment of the present invention;

FIG. 2C is a view showing part of a step in the method for manufacturing the solid-state battery according to the first embodiment of the present invention;

FIG. 2D is a view showing part of a step in the method for manufacturing the solid-state battery according to the first embodiment of the present invention;

FIG. 3A is a graph showing a charge-discharge curve of a solid-state battery according to an example of the present invention;

FIG. 3B is a graph showing charge-discharge curves of solid-state batteries according to examples of the present invention;

FIG. 4 is a graph showing a charge-discharge curve of a solid-state battery according to a comparative example of the present invention;

FIG. 5 is a graph showing the cross-sectional porosity of a solid electrolyte layer of the solid-state battery according to the example of the present invention; and

FIG. 6 is a graph showing the average cross-sectional pore size of the solid electrolyte layer of the solid-state battery according to the example of the present invention.

### DETAILED DESCRIPTION OF THE INVENTION

### Solid-State Battery

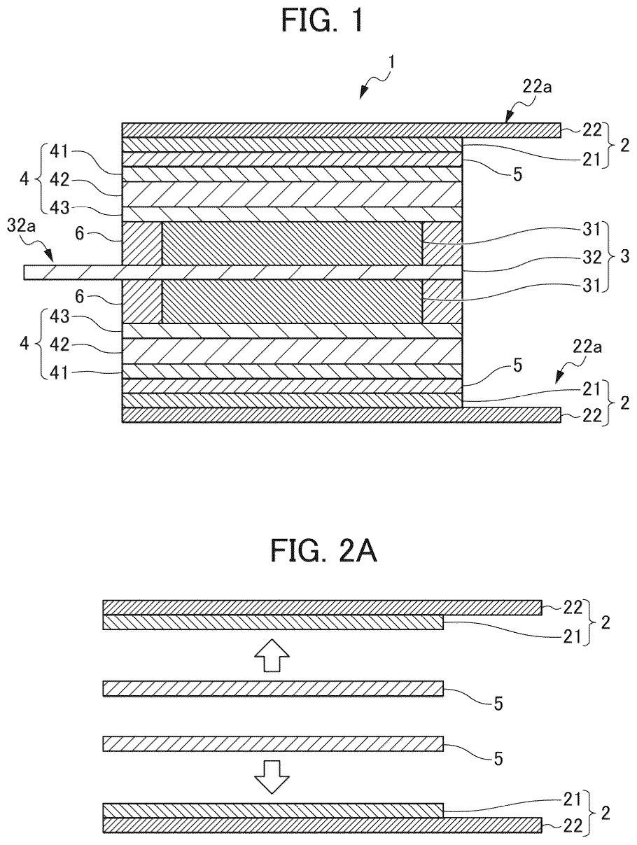

As shown in FIG. 1, a solid-state battery 1 manufactured by a manufacturing method according to the present invention has an electrode laminate configured such that a negative electrode layer 2, a solid electrolyte layer 4, and a positive electrode layer 3 are laminated in this order. In the present embodiment, a structure in which the negative electrode layer 2, the solid electrolyte layer 4, the positive electrode layer 3, the solid electrolyte layer 4, and the negative electrode layer 2 are laminated in this order as shown in FIG. 1 will be described as the multilayer structure of the solid-state battery 1. However, the structure of the solid-state battery 1 is not limited to above, and the solid-state battery 1 is only required to have a structure in which the solid electrolyte layer 4 is laminated between the negative electrode layer 2 and the positive electrode layer 3.

The solid electrolyte layer 4 in the solid-state battery 1 has at least a first solid electrolyte layer 41 disposed on the negative electrode layer 2 side, a second solid electrolyte layer 42 disposed adjacent to the first solid electrolyte layer 41, and a third solid electrolyte layer 43 disposed on the positive electrode layer 3 side. An intermediate layer 5 is disposed between the negative electrode layer 2 and the solid electrolyte layer 4.

The solid-state battery 1 is not particularly limited but may be a lithium-ion solid-state secondary battery or a lithium metal secondary battery.

### Negative Electrode Layer

The negative electrode layer 2 has a negative electrode active material layer 21 and a negative electrode current collector layer 22. The negative electrode active material layer 21 is not particularly limited but may be composed of a substance available as a negative electrode active material of a solid-state battery. The negative electrode active material layer 21 is preferably a lithium metal layer containing lithium metal as a negative electrode active material. This is because the negative electrode active material layer 21 can closely adhere to the solid electrolyte layer 4 with high adhesion force in the solid-state battery 1 according to the present invention even in a case where the negative electrode active material layer 21 is made of hard metal. Examples of the lithium metal include, in addition to lithium metal alone, a lithium alloy and the like. The negative electrode active material layer 21 may be composed of, other than the materials above, a silicon-based active material such as Si or a Si alloy, a lithium transition metal oxide such as lithium titanate (Li₄Ti₅O₁₂), a transition metal oxide such as TiO₂, Nb₂O₃, or WO₃, a metal sulfide, a metal nitride, a carbon material such as graphite, soft carbon, or hard carbon, or metallic indium, for example.

The negative electrode active material layer 21 may contain, in addition to the materials above, a material containable in a negative electrode active material layer of a solid-state battery. Examples of the above-described material include a solid electrolyte, a conductive auxiliary agent, a binder, and the like. The solid electrolyte includes those similar to the solid electrolytes contained in the solid electrolyte layer 4 to be described later. Examples of the conductive auxiliary agent include carbon black, natural graphite, a carbon fiber, a carbon nanotube, and the like. Examples of the binder include a fluorine-based polymer, a nitrile-based polymer, a polyester-based polymer, an acrylate-based polymer, a cellulose-based polymer, a styrene-based polymer, a styrene-butadiene-based polymer, a vinyl acetate-based polymer, a urethane-based polymer, a fluoroethylene-based copolymer, and the like.

The negative electrode current collector layer 22 is not particularly limited but may be composed of copper, nickel, stainless steel, or the like. Examples of the form of the negative electrode current collector layer 22 include the forms of foil, plate, mesh, non-woven fabric, foam, and the like. Part of the negative electrode current collector layer 22 is extended in a predetermined direction, thereby forming a negative electrode current collector tab 22a.

### Solid Electrolyte Layer

The solid electrolyte layer 4 is formed between the negative electrode layer 2 and the positive electrode layer 3. In the present embodiment, the solid electrolyte layer 4 has a structure in which the first solid electrolyte layer 41 disposed on the negative electrode layer side, the second solid electrolyte layer 42, and the third solid electrolyte layer 43 disposed on the positive electrode layer side are laminated in this order.

The first solid electrolyte layer 41 is disposed on the negative electrode layer side. The first solid electrolyte layer 41 may be disposed adjacent to the negative electrode layer 2. In a case where the solid-state battery 1 has the intermediate layer 5 as shown in FIG. 1, the first solid electrolyte layer 41 may be disposed adjacent to the intermediate layer 5. The first solid electrolyte layer 41 has a higher density than that of the second solid electrolyte layer 42, and is densified. I In the course of the densification, the first solid electrolyte layer 41 closely adheres to the intermediate layer 5 or the negative electrode layer 2. The first solid electrolyte layer 41 is densified and closely adheres to the intermediate layer 5 or the negative electrode layer 2 so that occurrence of abnormal electrodeposition can be reduced. Moreover, preferable battery performance can be obtained.

The density of the first solid electrolyte layer 41 is preferably 1.65 g/cm³ or more, more preferably 1.80 g/cm³ or more. The density of the first solid electrolyte layer 41 is not particularly limited but may be 2.00 g/cm³ or less.

A solid electrolyte material forming the first solid electrolyte layer 41 is not particularly limited, and is only required to be a material available as an electrolyte of a solid-state battery. Examples of the material include a sulfide solid electrolyte material, an oxide solid electrolyte material, a halide solid electrolyte, an inorganic solid electrolyte such as lithium-containing salt, a polymer-based solid electrolyte such as polyethylene oxide, and the like. The above-described solid electrolytes may be used alone, or two or more types of these solid electrolytes may be used in combination.

The solid electrolyte material forming the first solid electrolyte layer 41 is preferably in the form of particle. The particle size (D50, median size) of the solid electrolyte material forming the first solid electrolyte layer 41 is preferably 1 μm or less. With this configuration, the first solid electrolyte layer 41 can be easily densified. The particle size of the solid electrolyte material is more preferably 0.7 μm or less The particle size of the solid electrolyte material is not particularly limited but may be 50 nm or more.

The first solid electrolyte layer 41 may contain a material available for a solid electrolyte layer of a solid-state battery in addition to the solid electrolyte material. For example, the first solid electrolyte layer 41 may contain a binder. As the binder, a substance similar to that of the binder containable in the negative electrode active material layer 21 can be used. In a case where the binder is contained in the first solid electrolyte layer 41, the upper limit of the content of the binder is 25% by mass with respect to the total mass of the first solid electrolyte layer 41. The content of the binder is preferably 10% by mass or less, more preferably 1.3% by mass or less. With this configuration, the first solid electrolyte layer 41 can be easily densified, and the energy density of the solid-state battery 1 can be improved. The content of the binder may be 0% by mass.

The thickness (length of each layer in a lamination direction) of the first solid electrolyte layer 41 is preferably 7 μm or less. With this configuration, the first solid electrolyte layer 41 can be easily densified. The thickness of the first solid electrolyte layer 41 is more preferably 3 μm or less. The thickness of the first solid electrolyte layer 41 is not particularly limited but may be 1 μm or more.

The porosity of the first solid electrolyte layer 41 is preferably 7% or less. This configuration can be taken as a configuration in which the first solid electrolyte layer 41 is densified. The efficiency of charge transfer in the first solid electrolyte layer 41 is improved. The porosity of the first solid electrolyte layer 41 is more preferably 4% or less. The porosity of the first solid electrolyte layer 41 is not particularly limited but may be 1% or more.

The second solid electrolyte layer 42 is disposed adjacent to the first solid electrolyte layer 41. The second solid electrolyte layer 42 has a lower density than that of the first solid electrolyte layer 41. A solid electrolyte material forming the second solid electrolyte layer 42 is not particularly limited, and a material similar to the solid electrolyte material forming the first solid electrolyte layer 41 can be used. The particle size of the solid electrolyte material forming the second solid electrolyte layer 42 may be equal to or greater than the particle size of the solid electrolyte material forming the first solid electrolyte layer 41. Alternatively, a solid electrolyte material having a particle size equal to that of the solid electrolyte material forming the first solid electrolyte layer 41 and a solid electrolyte material having a particle size greater than that of the solid electrolyte material forming the first solid electrolyte layer 41 may be combined. With this configuration, the second solid electrolyte layer 42 can be densified.

As in the first solid electrolyte layer 41, the second solid electrolyte layer 42 may contain, for example, a binder in addition to the solid electrolyte material. The second solid electrolyte layer 42 may include a support. The support may be a three-dimensional structure such as mesh, woven fabric, non-woven fabric, an embossed body, a punched body, an expanded body, or foam. The second solid electrolyte layer 42 does not necessarily include the above-described support.

The thickness (length of each layer in the lamination direction) of the second solid electrolyte layer 42 is not particularly limited but may be 5 to 50 μm, for example.

The third solid electrolyte layer 43 is disposed on the positive electrode layer side. In the present embodiment, the third solid electrolyte layer 43 is disposed adjacent to a positive electrode active material layer 31 of the positive electrode layer 3. The third solid electrolyte layer 43 is disposed adjacent to the second solid electrolyte layer 42. That is, in the present embodiment, the third solid electrolyte layer 43 is disposed between the positive electrode active material layer 31 and the second solid electrolyte layer 42.

The configuration of the third solid electrolyte layer 43 may be similar to the configuration of the first solid electrolyte layer 41. The third solid electrolyte layer 43 is densified and closely adheres to the positive electrode active material layer 31 so that preferable battery performance can be obtained. An example of the preferable battery performance includes, for example, low resistance.

### Positive Electrode Layer

The positive electrode layer 3 has the positive electrode active material layer 31 and a positive electrode current collector layer 32. In the present embodiment, the positive electrode layer 3 has a configuration in which two positive electrode active material layers 31 are laminated on both surfaces of one positive electrode current collector layer 32. The configuration of the positive electrode layer 3 is not limited to above, and may have a configuration in which one positive electrode active material layer 31 is laminated on one surface of one positive electrode current collector layer 32.

The positive electrode active material layer 31 is not particularly limited but may be composed of a substance available as a positive electrode active material of a solid-state battery. Examples of a positive electrode active material forming the positive electrode active material layer 31 include a layered positive electrode active material particle of, for example, LiCoO₂, LiNiO₂, LiCoₓNi_{y}Mn_{z}O₂ (x+y+z=1), LiVO₂, or LiCrO₂, a spinel type positive electrode active material such as LiMn₂O₄, Li (Ni_{0.25}Mn_{0.75})₂O₄, LiCoMO₄, or Li₂NiMn₃O₈, an olivine type positive electrode active material such as LiCoPO₄, LiMnPO₄, or LifePO₄, solid solution oxide (Li₂MnO₃—LiMO₂ (M=Co, Ni, for example)), a conductive polymer such as polyaniline or polypyrrole, a sulfide such as Li₂S, CuS, a Li—Cu—S compound, TiS₂, FeS, MoS₂, or a Li—Mo—S compound, a mixture of sulfur and carbon, and the like. The above-described positive electrode active materials may be used alone, or two or more types of these materials may be used in combination.

An insulating frame 6 may be provided at the outer periphery of the positive electrode active material layer 31. The insulating frame 6 can prevent short-circuit of the solid-state battery 1, and can improve strength. In the present embodiment, the insulating frame 6 is disposed so as to cover the side surfaces of the two positive electrode active material layers 31 formed on both surfaces of the positive electrode current collector layer 32. Moreover, the insulating frame 6 contacts part of lamination surfaces of the positive electrode current collector layer 32, and has a gap in which a positive electrode current collector tab 32a to be described later extends. A material forming the insulating frame 6 is not particularly limited but may include, for example, an insulating oxide such as alumina, a resin such as polyvinylidene fluoride (PVDF), a rubber such as styrene-butadiene rubber (SBR), or the like.

The positive electrode current collector layer 32 is not particularly limited but may be composed of, for example, aluminum, stainless steel, conductive carbon (for example, graphite or carbon nanotubes), or the like. Examples of the form of the positive electrode current collector layer 32 include the forms of foil, plate, mesh, non-woven fabric, foam, and the like. Part of the positive electrode current collector layer 32 is extended in a predetermined direction, thereby forming the positive electrode current collector tab 32a.

### Intermediate Layer

The intermediate layer 5 is disposed between the negative electrode layer 2 and the solid electrolyte layer 4. The intermediate layer 5 has, for example, a function of causing lithium metal to uniformly precipitate in a case where the solid-state battery 1 is a lithium metal battery. Thus, an interface between the intermediate layer 5 and the first solid electrolyte layer 41 is stabilized. In a case where the solid-state battery 1 is a lithium metal secondary battery having an intermediate layer 5, the solid-state battery 1 may be an anode-free battery in which no negative electrode active material layer 21 is present upon initial charge. In this case, after initial charge and discharge, a lithium metal layer is formed as the negative electrode active material layer 21.

A substance forming the intermediate layer 5 is not particularly limited but may include, for example, a metal which can be alloyed with lithium, amorphous carbon, or the like. Examples of the metal which can be alloyed with lithium include tin (Sn), silicon (Si), zinc (Zn), magnesium (Mg), gold (Au), platinum (Pt), palladium (Pd), silver (Ag), aluminum (Al), bismuth (Bi), antimony (Sb), and the like. The metal which can be alloyed with lithium may be in the form of nanoparticle. Examples of the amorphous carbon include carbon blacks such as acetylene black, furnace black, and Ketjenblack, coke, activated carbon, and the like. The amorphous carbon may be easily-graphitizable carbon (soft carbon), or may be non-graphitizable carbon (hard carbon), a carbon nanotube (CNT), fullerene, or graphene. The intermediate layer may contain a binder in addition to the above-described substances.

### Method for Manufacturing Solid-State Battery

### First Embodiment

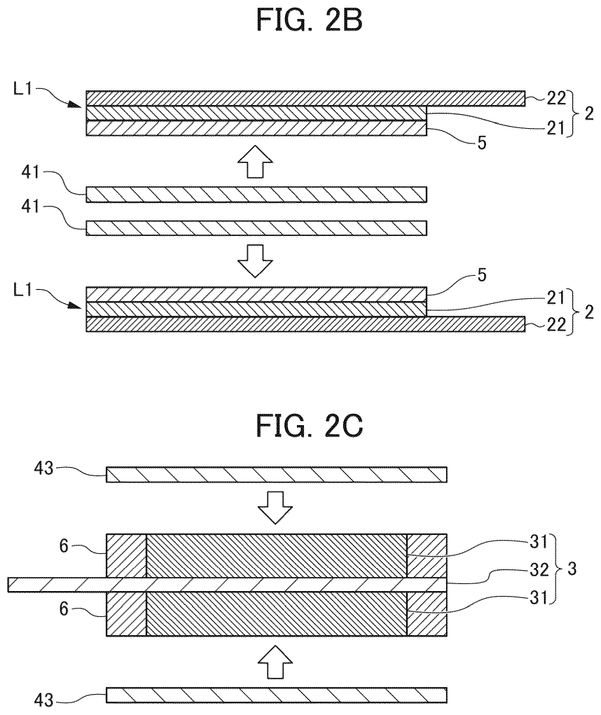

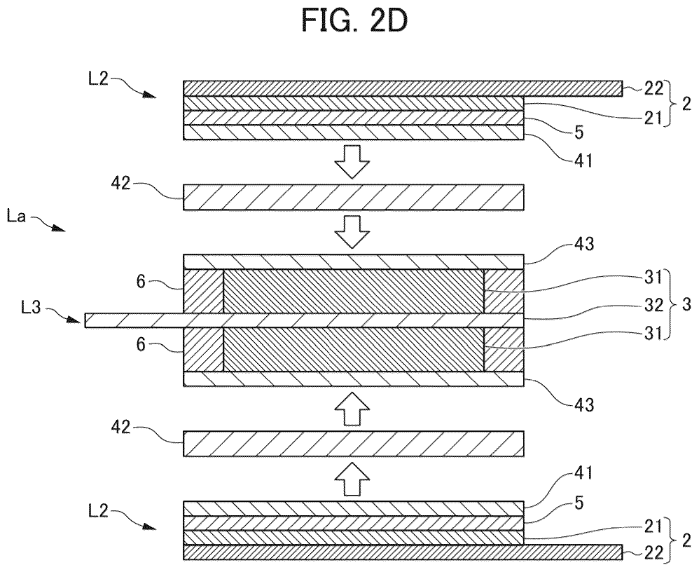

A method for manufacturing a solid-state battery according to the present embodiment will be described below with reference to FIGS. 2A to 2D. The method for manufacturing the solid-state battery according to the present embodiment is a method for manufacturing a solid-state battery having an electrode laminate La configured such that a negative electrode layer, an intermediate layer, a solid electrolyte layer, and a positive electrode layer are laminated in this order. The method for manufacturing the solid-state battery according to the present embodiment includes Step 1, Step 2A, Step 3, and Step 4A described below. The order of performing these steps may be an arbitrary order, except that Step 2A is performed subsequently to Step 1 and Step 4A is performed after Step 2A and Step 3.

As shown in FIG. 2A, Step 1 is a step of obtaining an intermediate layer-negative electrode layer laminate L1 by press-joining the negative electrode layer 2 and the intermediate layer 5. Specifically, a method for disposing the intermediate layer 5 on a negative electrode active material layer 21-side surface, which is a lamination surface, of the negative electrode layer 2 includes, for example, a method of transferring the intermediate layer 5 using an intermediate layer transfer sheet. The intermediate layer transfer sheet is obtained, for example, in such a manner that a slurry obtained by dispersing the material forming the intermediate layer 5 in a solvent is applied to and dried on a support sheet.

A pressure of pressing the negative electrode layer 2 and the intermediate layer 5 in Step 1 is not particularly limited as long as these layers can be joined to such an extent that the layers are not detached from each other in subsequent steps without excessive deformation of each of the negative electrode layer 2 and the intermediate layer 5. The pressure in Step 1 falls, for example, within a range of 300 MPa or more and 600 MPa or less.

As shown in FIG. 2B, Step 2A is a step of obtaining a solid electrolyte layer-intermediate layer-negative electrode layer laminate L2 by disposing the substance forming the first solid electrolyte layer 41 on the lamination surface of the intermediate layer 5 of the intermediate layer-negative electrode layer laminate L1 and press-joining these layers. A method for disposing the first solid electrolyte layer 41 on the lamination surface of the intermediate layer 5 may be a method using a solid electrolyte layer transfer sheet or a method using a solid electrolyte sheet formed in the form of sheet in advance. The solid electrolyte layer transfer sheet has a configuration similar to that of the above-described intermediate layer transfer sheet.

A pressure of pressing the intermediate layer-negative electrode layer laminate L1 and the first solid electrolyte layer 41 in Step 2A is preferably higher than a pressure of integrating the layers in Step 4A. With this configuration, the first solid electrolyte layer 41 can be densified. The pressure in Step 2A falls, for example, within a range of more than 500 MPa and 700 MPa or less. The pressure preferably falls within a range of 600 MPa or more and 700 MPa or less.

As shown in FIG. 2C, Step 3 is a step of obtaining a solid electrolyte layer-positive electrode layer laminate L3 by disposing the substance forming the third solid electrolyte layer 43 on the lamination surface of the positive electrode layer 3 and press-joining these layers. In the present embodiment, the positive electrode layer 3 is configured such that the positive electrode active material layers 31 are formed on both surfaces of the positive electrode current collector layer 32, and the third solid electrolyte layers 43 are disposed on both the positive electrode active material layers 31. In a case where the positive electrode layer 3 is configured such that the positive electrode active material layer 31 is formed only on one surface of the positive electrode current collector layer 32, the third solid electrolyte layer 43 may be disposed on the single positive electrode active material layer 31. A method for disposing the third solid electrolyte layer 43 may be similar to that in Step 2A.

A pressure of pressing the positive electrode layer 3 and the third solid electrolyte layer 43 in Step 3 is preferably higher than the pressure for integrating the layers in Step 4A. With this configuration, the third solid electrolyte layer 43 can be densified. The pressure in Step 3 falls, for example, within a range of 700 MPa or more and 1200 MPa or less.

As shown in FIG. 2D, Step 4A is a step of obtaining the electrode laminate La by disposing the second solid electrolyte layer 42 between the solid electrolyte layer-intermediate layer-negative electrode layer laminate L2 and the solid electrolyte layer-positive electrode layer laminate L3 so as to face the solid electrolyte layers and press-joining these layers. As the second solid electrolyte layer 42, for example, one formed in the form of a sheet in advance may be used. In the present embodiment, the solid electrolyte layer-positive electrode layer laminate L3 has the third solid electrolyte layers 43 on both surfaces. Thus, each layer is disposed such that two second solid electrolyte layers 42 are disposed so as to face both surfaces of the solid electrolyte layer-positive electrode layer laminate L3 and are further sandwiched between two solid electrolyte layer-intermediate layer-negative electrode layer laminates L2. In a case where the solid electrolyte layer-positive electrode layer laminate L3 has the third solid electrolyte layer 43 only on one surface, one second solid electrolyte layer 42 may be disposed so as to face the third solid electrolyte layer 43, and one solid electrolyte layer-intermediate layer-negative electrode layer laminate L2 may be further disposed thereon.

Since Step 4A is a step of integrating the layers, the pressure is preferably set to such an extent that each layer is not excessively deformed. The pressure in Step 4A falls, for example, within a range of 300 MPa or more and 500 MPa or less. Even when the pressure in Step 4A is within the above-described range, the first solid electrolyte layer 41 is sufficiently densified in advance in Step 2A. Thus, the occurrence of the abnormal electrodeposition can be reduced, and the preferable battery performance can be obtained.

In each step above, a device for the press-joining is not particularly limited, and a roll press device or a flat plate press device can be used. In a case where the press-joining is performed using the roll press device, a direction of delivering a target to be press-joined to the roll press device may be the same direction or different directions. For example, a direction of delivering the target to the roll press device in Step 2A and Step 3 and a direction of delivering the target to the roll press device in Step 4A may be different from each other and be perpendicular to each other. With this configuration, a probability of a layer with a low Young's modulus being extended in one direction, the solid electrolyte layer 4 being pulled accordingly, and a defect being caused in the solid electrolyte layer 4 is reduced.

The preferred embodiment of the present invention has been described above, but the present invention is not limited to the embodiment above. The solid-state battery 1 may have a configuration available for a solid-state battery, such as an exterior body, in addition to the electrode laminate shown in FIG. 1. The method for manufacturing the solid-state battery according to the first embodiment may have an arbitrary step in addition to those described above.

Hereinafter, the present invention will be described in more detail with reference to examples. The present invention is not limited to the contents of the examples below.

### EXAMPLES

### Example 1

An electrode laminate configured such that a negative electrode layer, an intermediate layer, a solid electrolyte layer, and a positive electrode layer are laminated in this manner was produced in the following steps.

### Production of Positive Electrode Layer

As a positive electrode current collector, aluminum foil having a thickness of 12.0 μm was prepared. As a positive electrode active material, 60.0 parts by mass of lithium-nickel-cobalt-manganese composite oxide (NCM622), 35.8 parts by mass of a sulfide solid electrolyte as a solid electrolyte, 2.9 parts by mass of acetylene black (DENKA BLACK (registered trademark) Li-100 manufactured by Denka Company Limited) as a conductive auxiliary agent, and 1.3 parts by mass of a styrene-butadiene rubber-based (SBR-based) binder were mixed. The resultant mixture was dispersed in a solvent, and in this manner, a positive electrode active material slurry was prepared. The resultant positive electrode active material slurry was applied to and dried on both surfaces of the positive electrode current collector by a bar coater such that the basis weight thereof after drying becomes 27.4 mg/cm², and in this manner, a positive electrode layer was produced.

### Production of Intermediate Layer Transfer Sheet

Sn Particles (median size: 0.07 μm) as metal nanoparticles and acetylene black (median size: 0.05 μm) as amorphous carbon were used. Then, 95 parts by mass of the above-described mixture and 5 parts by mass of a PVDF-based binder were mixed in total. The resultant mixture was dispersed in a solvent, and an intermediate layer slurry was prepared. The resultant intermediate layer slurry was applied to and dried on a support sheet, and an intermediate layer transfer sheet was produced so as to have a final thickness of 4 to 10 μm.

### Production of Solid Electrolyte Transfer Sheets for First and Third Solid Electrolyte Layers

Fluid dispersion of a sulfide solid electrolyte (median size: 0.7 μm) was applied to and dried on a support sheet, and in this manner, a solid electrolyte transfer sheet was produced.

### Production of Second Solid Electrolyte Layer

A sulfide solid electrolyte (A) having a median size of 3 um and a sulfide solid electrolyte (B) having a median size of 0.7 μm were mixed in a ratio of 8:2. A styrene-butadiene rubber-based (SBR-based) binder was used as a binder. Then, 94.5 parts by mass of the above-described solid electrolyte and 5.5 parts by mass of the binder were mixed. The resultant mixture was dispersed in a solvent, and in this manner, a solid electrolyte slurry was prepared. Non-woven fabric as a base was immersed in the resultant solid electrolyte slurry, and was dried. In this manner, a second solid electrolyte layer was produced.

### Production of Negative Electrode Layer

As a negative electrode current collector, copper foil having a thickness of 10 μm was prepared. Metal lithium foil having a thickness of 6.5 μm was laminated on a surface of the copper foil, and in this manner, a negative electrode layer was produced.

### Production of Electrode Laminate

The intermediate layer of the intermediate layer transfer sheet was transferred onto a surface of the metal lithium foil of the negative electrode layer, and in this manner, an intermediate layer was formed. These layers were press-joined with a joint pressure of 400 MPa at 25° C., and in this manner, an intermediate layer-negative electrode layer laminate was produced. Subsequently, the solid electrolyte of the solid electrolyte transfer sheet was transferred onto a surface of the intermediate layer of the intermediate layer-negative electrode layer laminate, and in this manner, a first solid electrolyte layer was formed. Subsequently, the intermediate layer-negative electrode layer laminate and the first solid electrolyte layer were press-joined with a joint pressure of 600 MPa at 25° C., and in this manner, a solid electrolyte layer-intermediate layer-negative electrode layer laminate was produced. Moreover, the solid electrolyte of the solid electrolyte transfer sheet was transferred onto surfaces of two positive electrode active material layers of the positive electrode layer, and in this manner, third solid electrolyte layers were formed. Subsequently, the positive electrode layer and the third solid electrolyte layers were press-joined with a joint pressure of 800 MPa at 25° C., and in this manner, a solid electrolyte layer-positive electrode layer laminate was produced. Next, two second solid electrolyte layers were disposed so as to sandwich the solid electrolyte layer-positive electrode layer laminate from both sides, and two solid electrolyte layer-intermediate layer-negative electrode layer laminates were further disposed outside such a laminate. Then, these three laminates were press-joined with a joint pressure of 500 MPa at 25° C. A roll press device was used for the pressing. In this manner, an electrode laminate according to Example 1 was produced.

### Example 2

An electrode laminate according to Example 2 was produced in a manner similar to that of Example 1, except that only acetylene black was used as an intermediate layer transfer sheet.

### Comparative Example 1

An electrode laminate according to Comparative Example 1 was produced in a manner similar to that of Example 1, except that no first solid electrolyte layer was formed. That is, no solid electrolyte layer-intermediate layer-negative electrode layer laminate was produced, two second solid electrolyte layers were disposed so as to sandwich a solid electrolyte layer-positive electrode layer laminate from both sides, and two intermediate layer-negative electrode layer laminates were further disposed outside such a laminate. Then, these three laminates were press-joined with a joint pressure of 500 MPa at 25° C. A roll press device was used for the pressing. In this manner, the electrode laminate according to Comparative Example 1 was produced.

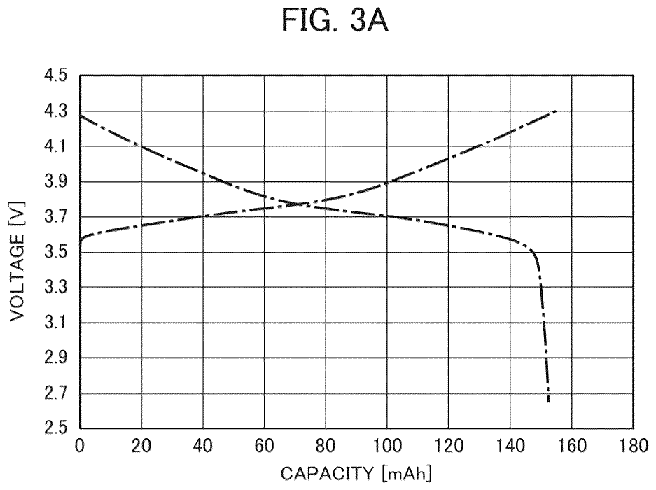

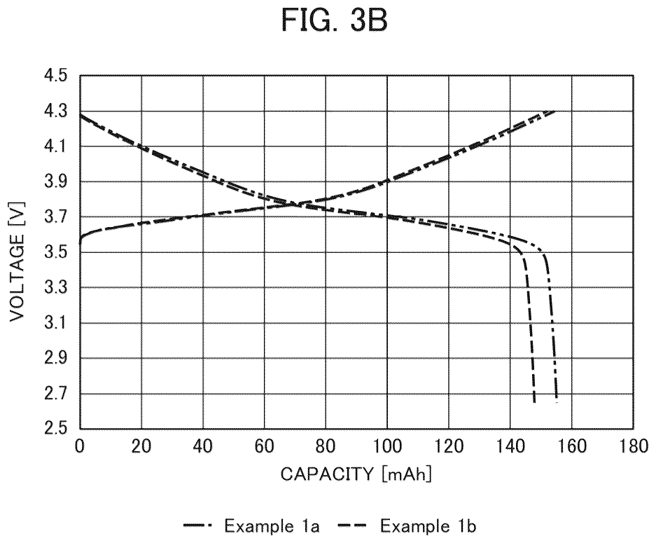

FIG. 3A shows charge-discharge test results for the solid-state battery according to Example 2. Similarly, FIG. 3B shows charge-discharge test results for the solid-state battery according to Example 1. Test conditions are similar to those of FIG. 3A. N=2 is applied to Example 1, and results are shown as Example 1a and Example 1b. A charge-discharge efficiency calculated from FIGS. 3A and 3B was 100.4% in Example 1a, 97.2% in Example 1b, and 98.5% in Example 2, which clearly shows that a preferable charge-discharge efficiency was obtained.

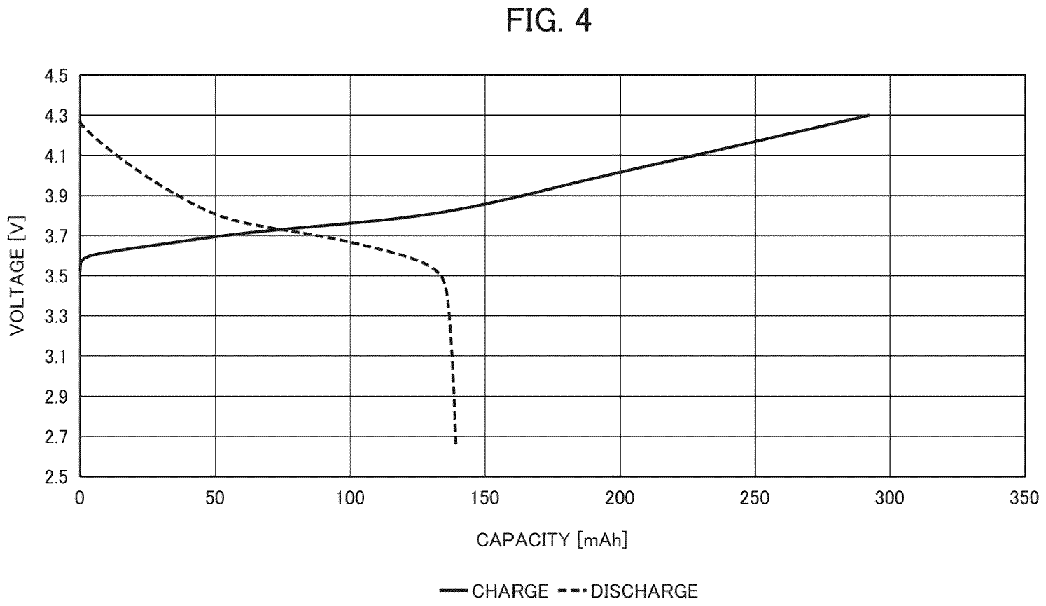

FIG. 4 shows charge-discharge test results of the solid-state battery according to Comparative Example 1. Test conditions are similar to those of FIG. 3A. FIG. 4 clearly shows that a voltage upon charge did not increase with respect to a discharge capacity and overcharge occurred.

### Measurement of Cross-Sectional Porosity

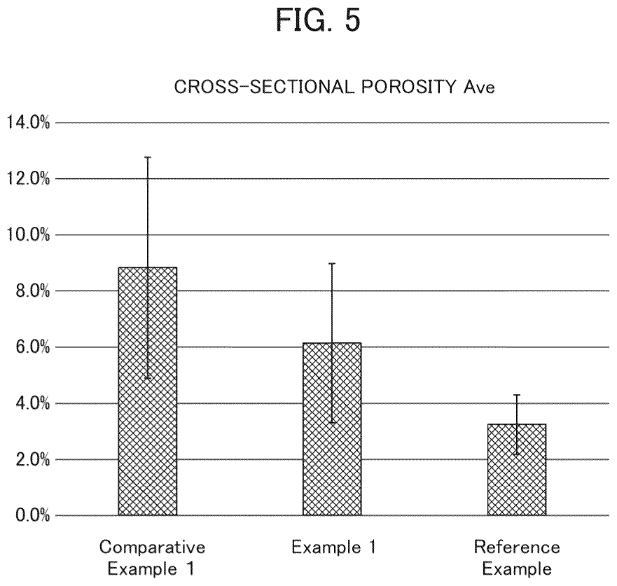

FIG. 5 is a graph showing comparison of a cross-sectional porosity in the vicinity of an interface between the intermediate layer and the solid electrolyte layer in the electrode laminates according to Comparative Example 1,Example 1, and a reference example. The porosity (%) was measured as follows. First, a SEM cross-sectional image of the target solid-state battery was acquired, and from a target region (solid electrolyte layer in the vicinity of the interface between the intermediate layer and the solid electrolyte layer in the electrode laminate), pores were extracted by image processing. Subsequently, the total area of the calculated pores was calculated, and a numerical value obtained by dividing the total area by the total area of the target region was taken as the porosity (%). Note that the reference example is an example where an electrode laminate was produced in a manner similar to that of Example 1, except that a warm isostatic pressing (WIP) device was used instead of the roll press device. FIG. 5 clearly shows that the above-described cross-sectional porosity of the electrode laminate according to Example 1 was lower than the above-described cross-sectional porosity of the electrode laminate according to Comparative Example 1 although not so low as in the reference example and the first solid electrolyte layer was densified.

### Measurement of Average Cross-sectional Pore Size

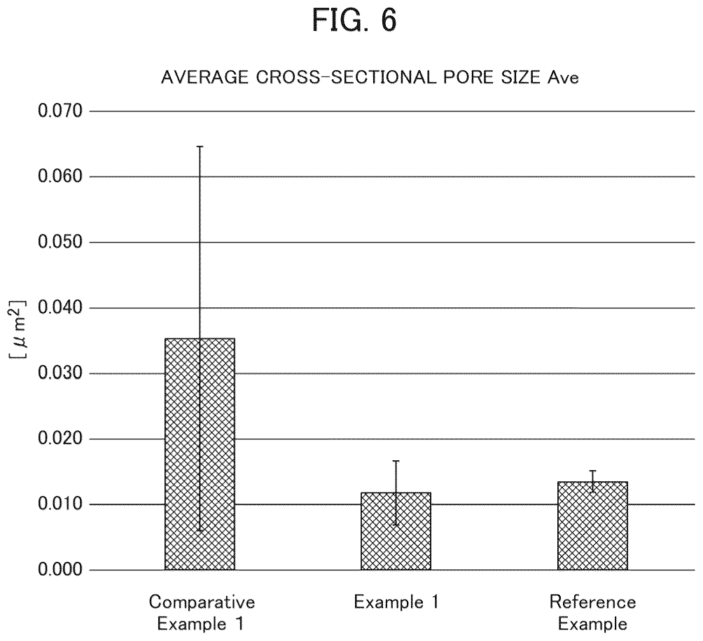

FIG. 6 is a graph showing comparison of an average cross-sectional pore size in the vicinity of the interface between the intermediate layer and the solid electrolyte layer in the electrode laminates according to Comparative Example 1, Example 1, and the reference example. The average cross-sectional pore size was calculated by calculating the size of the pores calculated upon calculation of the above-described porosity (%). FIG. 6 clearly shows that the above-described average cross-sectional pore size of the electrode laminate according to Example 1 was lower than the above-described average cross-sectional pore sizes of the electrode laminates according to the reference example and Comparative Example 1 and the first solid electrolyte layer was densified.

### EXPLANATION OF REFERENCE NUMERALS

1 Solid-State Battery
2 Negative Electrode Layer
3 Positive Electrode Layer
4 Solid Electrolyte Layer
41 First Solid Electrolyte Layer
42 Second Solid Electrolyte Layer
43 Third Solid Electrolyte Layer
5 Intermediate Layer
L1 Intermediate Layer-Negative Electrode Layer Laminate
L2 Solid Electrolyte Layer-Intermediate Layer-Negative Electrode Layer Laminate
L3 Solid Electrolyte Layer-Positive Electrode Layer Laminate
La Electrode Laminate

What is claimed is:

1. A method for manufacturing a solid-state battery having an electrode laminate configured such that a negative electrode layer, an intermediate layer, a solid electrolyte layer, and a positive electrode layer are laminated in this order,
the solid electrolyte layer including a first solid electrolyte layer disposed on a negative electrode layer side, a second solid electrolyte layer disposed adjacent to the first solid electrolyte layer, and a third solid electrolyte layer disposed on a positive electrode layer side, comprising:
obtaining an intermediate layer-negative electrode layer laminate by press-joining the negative electrode layer and the intermediate layer;
obtaining a solid electrolyte layer-intermediate layer-negative electrode layer laminate by disposing a substance forming the first solid electrolyte layer on a lamination surface of the intermediate layer of the intermediate layer-negative electrode layer laminate and press-joining the intermediate layer-negative electrode layer laminate and the first solid electrolyte layer;
obtaining a solid electrolyte layer-positive electrode layer laminate by disposing a substance forming the third solid electrolyte layer on a lamination surface of the positive electrode layer and press-joining the positive electrode layer and the third solid electrolyte layer; and
obtaining an electrode laminate by disposing the second solid electrolyte layer between the solid electrolyte layer-intermediate layer-negative electrode layer laminate and the solid electrolyte layer-positive electrode layer laminate so as to face the solid electrolyte layers and press-joining the second solid electrolyte layer, the solid electrolyte layer-intermediate layer-negative electrode layer laminate, and the solid electrolyte layer-positive electrode layer laminate.

2. The method for manufacturing the solid-state battery according to claim 1, wherein a pressure in the obtaining the solid electrolyte layer-intermediate layer-negative electrode layer laminate is higher than a pressure in the obtaining the electrode laminate.

3. The method for manufacturing the solid-state battery according to claim 2, wherein the pressure in the obtaining the solid electrolyte layer-intermediate layer-negative electrode layer laminate is more than 500 MPa and 700 MPa or less.

4. The method for manufacturing the solid-state battery according to claim 2, wherein the pressure in the obtaining the electrode laminate is 300 MPa or more and 500 MPa or less.

5. The method for manufacturing the solid-state battery according to claim 1, wherein a pressure in the obtaining the solid electrolyte layer-positive electrode layer laminate is higher than a pressure in the obtaining the electrode laminate.
